(19) United States
(12) Patent Application Publication
(10) Pub. No.: US 2026/0310476 A1
(43) Pub. Date: Oct. 8, 2026

(54) ABILITY-BASED USER INPUT INTERFACE

(71) Applicant: Panasonic Well LLC, Palo Alto, CA (US)

(72) Inventor: Ramin Firoozye, San Francisco, CA (US)

(21) Appl. No.: 19/276,750

(22) Filed: Jul. 22, 2025

Related U.S. Application Data
(60) Provisional application No. 63/783,813, filed on Apr. 4, 2025.

(51) Int. Cl. G06F 9/451; G06F 3/04845

(52) U.S. Cl. CPC G06F 9/453; G06F 3/04845

(57) ABSTRACT

Systems and methods for dynamically updating user interface elements based on detecting degradation of user ability are provided. A computer-implemented method can include identifying an input intent and an output intent associated with an application. The computer-implemented method can also include accessing an ability profile of a user. The ability profile can include one or more characteristics associated with a cognitive or sensory ability of the user. The computer-implemented method can also include processing the input intent, the output intent, and the ability profile to determine an accessibility configuration that includes instructions to dynamically modify or replace content of the application. The computer-implemented method can also include selecting a set of user-interface elements corresponding to the content. The computer-implemented method can also include adjusting one or more content characteristics of the set of user-interface elements according to the accessibility configuration.

### CROSS-REFERENCES TO RELATED APPLICATIONS

The present patent application claims the priority benefit of U.S. Provisional Patent Application 63/783,813 filed Apr. 4, 2025 and is related to U.S. Patent Applications entitled “MULTI-MODAL INTERACTION FOR PEOPLE WITH DISABILITY” (POL Ref. 109304-845017-009000US) filed Jul. 22, 2025 and “SEAMLESS TRANSITION BETWEEN ON-DEVICE, MOBILE, AND CLOUD-BASED AI/ML MODELS” (POL Ref. 109304-845002-009200US) filed Jul. 22, 2025, U.S. Provisional Application 63/783,817 filed Apr. 4, 2025 entitled “MULTI-MODAL INTERACTION FOR PEOPLE WITH DISABILITY” and U.S. Provisional Application 63/783,829 filed Apr. 4, 2025 entitled “SEAMLESS TRANSITION BETWEEN ON-DEVICE, MOBILE, AND CLOUD-BASED AI/ML MODELS”, the disclosures of which are incorporated herein by reference in its entirety for all purposes.

### FIELD

The present disclosure relates generally to updating user interface elements based on a user's cognitive and sensory attributes. In one example, the systems and methods described herein may be used to dynamically update user interface elements of an application based on detecting degradation of user ability.

### SUMMARY

Disclosed embodiments may provide techniques for dynamically updating user interface elements based on detecting degradation of user ability. A computer-implemented method can include identifying an input intent associated with an application. In some instances, the input intent identifies one or more intended inputs to the application to trigger a particular event. The computer-implemented method can also include identifying an output intent associated with the application. In some instances, the output intent identifies one or more expected outputs associated with the particular event being triggered in response to the one or more intended inputs. The computer-implemented method can also include accessing an ability profile of a user. The ability profile can include one or more characteristics associated with a cognitive or sensory ability of the user, and the ability profile is generated by a degradation-monitoring system. The computer-implemented method can also include processing the input intent, the output intent, and the ability profile to determine an accessibility configuration that includes instructions to dynamically modify or replace content of the application. In some instances, dynamically modifying or replacing the content increases accessibility of the application by the user. The computer-implemented method can also include selecting a set of user-interface elements corresponding to the content. The computer-implemented method can also include adjusting one or more content characteristics of the set of user-interface elements according to the accessibility configuration.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 illustrates a computing environment of a user-interaction system implementing an adaptive ability-based input and output interface, according to some embodiments.

FIG. 2 illustrates a schematic diagram of techniques for detection and degradation of user ability, according to some embodiments.

FIG. 3 illustrates a schematic diagram for automatic disability regression measurement, according to some embodiments.

FIG. 4 illustrates a mechanism to map application intent to outputs and inputs, according to some embodiments.

FIG. 5 shows an illustrative example of a process for dynamically updating a user interface based on detection and degradation of user ability, in accordance with some embodiments.

FIG. 6 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### I. Techniques for Implementing an Ability-Based User Input Interface

### A. Overview

The elderly and disabled often have difficulty navigating the user-interface of modern applications. An elderly user with reduced dexterity struggles to tap small buttons on a smartphone app, often missing the intended target. Similarly, a user with motor disability who relies on a trackball or voice commands may find it difficult to navigate menus that require precise cursor movements or multi-step interactions. The diminished abilities can include, but are not limited to eyesight, hearing, speaking, touch, motor control, comprehension, and memory.

Various techniques have been implemented to address the above challenges. For example, existing techniques allow a user to enlarge the font of the application or provide closed captions for certain audio content. However, such existing techniques are often targeted at specific users (e.g., sight impaired) and require very little change at the application level. In addition, the existing techniques are typically hard-coded into the application and may not further adjust its accessibility features based on the user's abilities continue to diminish over time.

To address the aforementioned deficiencies, the present techniques provide a user-interaction system (also referred herein as “AbleUI”) that can be implemented to adapt to individual users and modify itself as those abilities change over time. For example, a user who is hearing impaired may be presented with captioning, and one who is color blind or has cataracts with a user interface that is modified with adaptive colors, larger fonts, or brighter colors. In some instances, AbleUI is configured to analyze user-interactions (e.g., input, output, sequence/workflow) out of individual applications and adapts a corresponding user interface of the applications to a range of user disabilities.

As a result, various applications can allow the user interactions to be dynamically and consistently adapted to individual users. The application can include one or more configurations indicating what output is expected to show the user and what type of input they need to receive before advancing to the next step. The subsequent operations resulting from the input may itself also be abstracted to allow complex workflows to be simplified for those with comprehension or memory problems (for example, by removing too many questions and applying defaults). As a result, the user-interaction system can identify from the application developer on their preferred presentation mode, for example a template, stylesheets, grid, or presentation markup. The configuration can encode what type of output data they need presented to the user, and what type of input they expect.

At runtime, the AbleUI system would dynamically analyze the user's personal ability levels along a series of attributes associated with the input, then generate the best method of presenting information and receiving additional input on a graphical user interface (GUI). The AbleUI system can also handle multiple modes of input/output for the same interaction. Such configuration frees the user to choose whatever method best suits their needs.

### B. Computing Environment

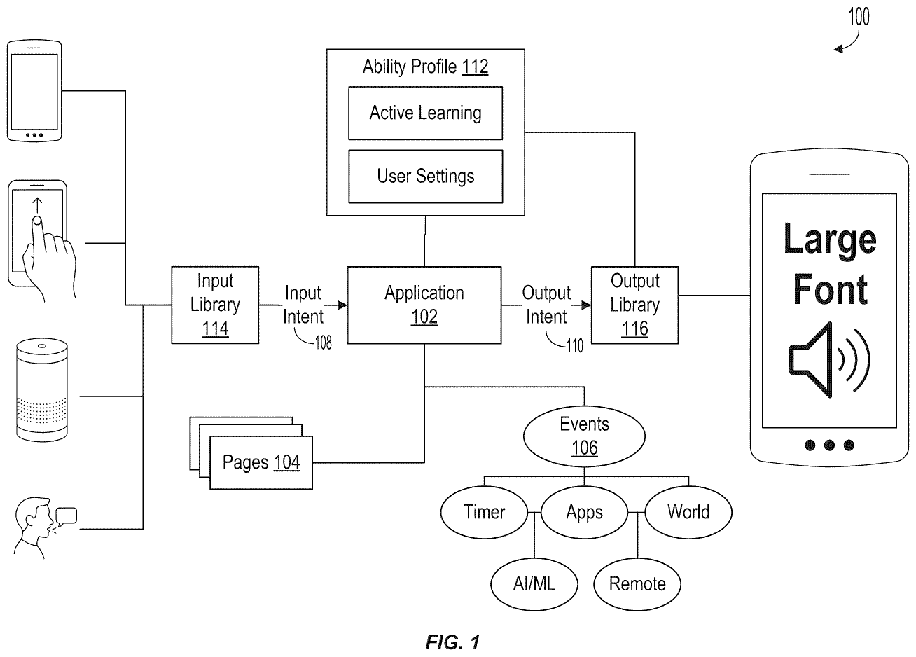

FIG. 1 illustrates a computing environment of a user-interaction system 100 implementing an adaptive ability-based input and output interface, according to some embodiments. In several embodiments, the user-interaction system 100 can be implemented as a subsystem of a device that runs alongside multiple applications. To dynamically generate content that adapt to individual users and modify itself as those abilities change over time, the user-interaction system 100 can be encapsulated as a software development kit (SDK) as well as an on-device background service or process (to track, process, and proxy events), or a cloud-based service, such that the features can be accessed and embedded in the application, along with a runtime, and active system processes.

An application 102 can be encoded to identify types of data that need to be presented to the user, and what type of input they expect. Such “intent” is expressed in a mode-independent fashion, allowing the user-interaction system 100 to determine how best to dynamically generate UI/UX controls for specific application usages and various types of users.

As shown in FIG. 1, the user-interaction system 100 can also access a plurality of application components associated with an application 102. In some instances, the application components can include pages 104 and events 106. As used herein, the term “page” refers to a distinct screen or view within the application 102 that presents content and user interface (UI) elements. Each page typically serves a specific function, such as displaying a user profile, showing a list of items, or providing a form for input. In some instances, the page can include various input and output graphical user interface elements that can be presented on a user interface, in which certain interactions with the user elements trigger an action or an event.

The term “event” refers to any user action or system occurrence that triggers a response within the application 102. Events can be triggered based on user interactions, background processes, or external inputs. Example types of events can include user events (e.g., taps, swipes, long presses, text input) and system events (e.g., application lifecycle changes, network status updates, push notifications). In some instances, events are typically handled using event listeners, callbacks, or reactive programming techniques to ensure the application 102 responds appropriately to different actions. The events 106 associated with a given page can specify one or more outputs that are triggered based on input data inputted by the user. For example, the event 106 can include a navigation from one application page to another page based on the user tapping a particular user-interface element. In some instances, a sequence or chain of events 106 can be determined to provide a flow of data to be presented and entered by the user across a plurality of pages of the application 102. In some instances, the events 106 can be triggered based on a failure of providing user input within a specified time period. For example, a user with hearing loss may not be able to respond to a page element that includes audio instructions.

### 1. Input and Output Intents

In some instances, for one or more of the events 106 of the application 102, the user-interaction system 100 can identify an input intent 108 or an output intent 110. The input intent 108 identifies one or more intended inputs across one or more pages 104 to trigger a corresponding event 106. In some instances, the input intent 108 is determined based on the types of content elements presented on a particular page of the application 102. As an illustrative example, the input intent 108 can include a prompt for selecting a small thumbnail image depicting palm trees and beach. An example modification to the page 104 based on the input intent 108 is to enlarge the image and any corresponding fonts for users with vision impairments.

The output intent 110 identifies one or more expected outputs associated with the event 106 triggered in response to user input. Continuing with the example of selecting the thumbnail image (e.g., image of a beach with palm trees), the output intent 110 is to navigate to another page of the application 102 that plays a video of Cancun beaches and resorts. An example modification to the video page based on the output intent 110 is to generate closed captions for users with hearing impairments.

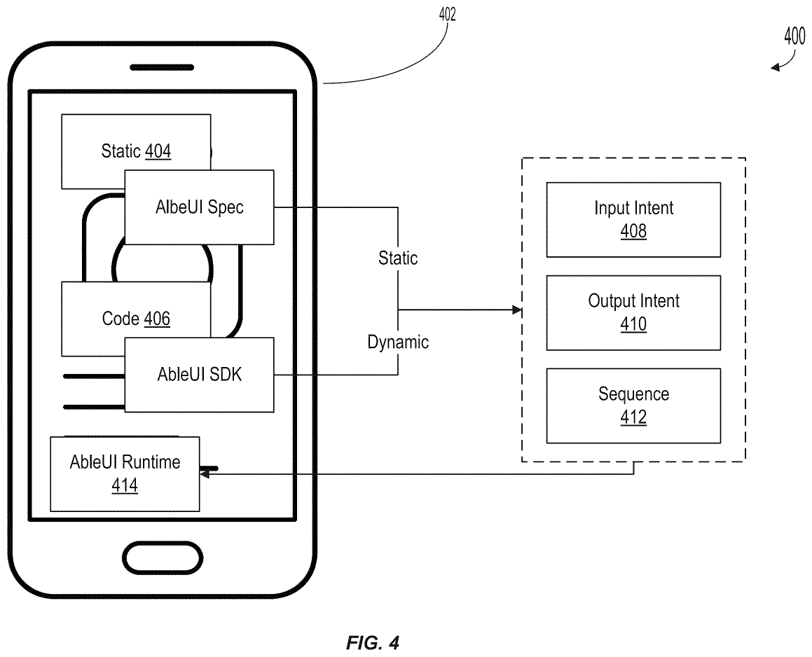

By specifying “intent” rather than individual steps, the user-interaction system 100 can allow the developers to implement features that best adapt to each user's abilities without burdening an application to fixed hard-coded system of screens and inputs. Examples techniques for specifying input intent 108 and output intent 110 are further described in FIG. 4 and Section 1.E of the present disclosure.

### 2. Ability Profile

The user-interaction system 100 can also access an ability profile 112 to determine how the interface elements can be modified to increase accessibility of the application 102. For example, the ability profile 112 can store any type of user data that identifies one or more characteristics associated with ability degradation of a corresponding user. For example, the ability profile 112 can include a name, an address, age, and gender of the user. In some instances, the ability profile 112 can determine estimated level of ability degradation and rates of degradation change over a time course, either of which can be determined based on active learning of computing operations (e.g., inputs, failure to respond to certain pages) performed by the user across various applications. The active learning facilitates the ability profile 112 to be dynamically updated in real-time.

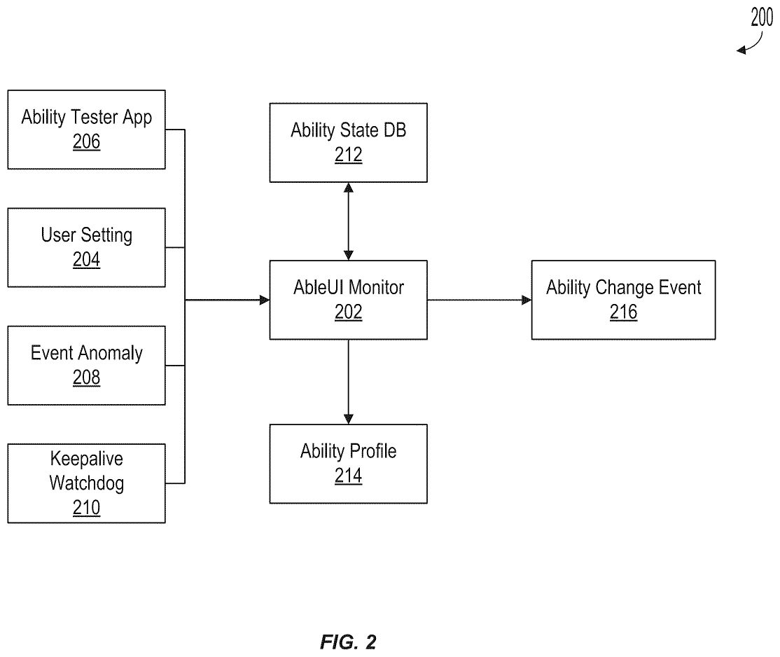

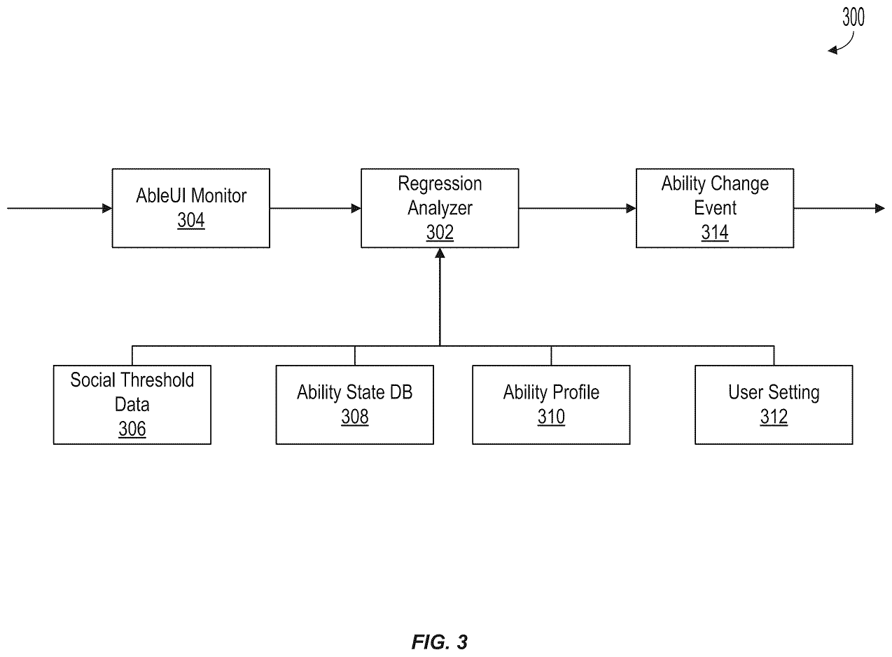

For example, if the user frequently enters wrong text information into the application, the ability profile 112 can indicate that user may be associated with a motor impairment. In some instances, user settings of the ability profile 112 can also indicate certain impairments or disabilities associated with the user. For example, if the user settings indicate the font and content to be displayed larger on the screen, the ability profile 112 can indicate a possible vision impairment of the user. Example techniques of determining the estimated level of ability degradation and the rates of degradation change are further described in FIGS. 2 and 3, and Sections I.C and I.D. of the present disclosure.

### 3. Accessibility Configuration

The user-interaction system 100 can then generate an accessibility configuration that includes script, executable code, or instructions to dynamically modify or replace content or interface elements presented in one or more pages of the application 102. The accessibility configuration can be determined based on the input intent 108, the output intent 110, and an ability profile 112 of the user. For example, if the input intent 108 specifies navigating to the particular page of the application 102 by clicking a small radio button, the accessibility configuration can include instructions to replace the radio button with an interaction with an accessory device (e.g., smart speakers) to navigate to the particular page.

In some embodiments, the accessibility configuration can be generated using a machine-learning model to process the input intent 108, the output intent 110, and the ability profile 112. Examples of the machine-learning model (including sub-models of the multimodal model) can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods.

In some instances, the machine-learning model is a transformer model (e.g., a large-language model (LLM)) obtained from a models database. In some instances, the machine-learning model is trained using self-supervised learning based on a large corpus of text data, such that the machine-learning model can generate narratives. In addition to training the model, various prompts can be used for prompt engineering of the machine-learning model for generating the narratives. Examples of the machine-learning model can include, but are not limited to, BERT model, Claude LLM, Falcon 40B, Ernie, GPT-3, GPT-3.5, GPT 4, Lamda, and Llama.

An illustrative example process of training and deploying the transformer model (e.g., a GPT model) is as follows. For the training dataset (e.g., the previous input data and accessibility configuration), the masked self-attention process can begin by transforming each word in a given training text sequence into three vectors: the query (Q), key (K), and value (V) vectors. A Q vector can represent what information the token is querying about other tokens, a K vector can represent the token's context used to establish relationships with other tokens, and a V vector can represent the token's actual content/information. In some instances, the Q, K, and V vectors can be obtained by multiplying the input embeddings by learned weight matrices.

An attention score for a particular word can be calculated by taking the dot product of the Q vector of the word with the K vectors of all words in the sequence, thereby producing a score that reflects the relevance of each word pair. The attention scores can be used as weights, which can be applied to the Q, K, V vectors to generate a weighted contextual representation of the particular word. Stated differently, the attention score can be used as a weight to transform the Q, K, V vectors of a given word to generate a weighted, computed representation that can be used to train the corresponding transformer model.

In some instances, a mask can be applied to the self-attention mechanism such that a contextual representation of a given token is determined without weights associated with future tokens. As a result, an attention score of a particular token can be adjusted to disregard information from tokens that have not been processed yet. The attention scores can then be scaled by the square root of the key dimension to stabilize training and passed through a softmax function to convert the attention scores into probabilities, ensuring they sum to one. The transformation can identify the most relevant words while downplaying less important ones. The resulting attention weights can then be used to compute a weighted sum of the V vectors, thus producing a new contextual representation for each token that incorporates contextual information from the entire sequence.

To enhance the model's ability to capture various types of relationships, self-attention mechanisms can use multiple sets of Q, K, and V matrices, also referred to as multi-head attention. Each set, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

The transformer model can then be trained using autoregressive language modeling to predict a subsequent token of a target sequence based on the contextual representations that represent the preceding tokens. For each position in the sequence, the transformer model accesses a contextual representation of the token, which was generated using masked self-attention mechanism. The transformer model can then output a probability distribution over a vocabulary for the subsequent token, conditioned on the sequence of preceding tokens. The subsequent token can then be compared with a corresponding token of the training data to calculate a loss. The loss measures the discrepancy between the predicted token and the actual token, providing a signal for the model to adjust its parameters. The loss can then be used to adjust parameters of the transformer model, including the parameters of the Q, K, V matrices.

Through iterative training iterations, the transformer model learns to minimize this loss across the entire training dataset. This process ensures that the model generates coherent and contextually appropriate sequences by leveraging the learned representations and adjusting its parameters based on the training data.

In some instances, the user-interaction system can construct one or more prompts that can be submitted with the input intent 108, the output intent 110, and the ability profile 112 to enhance and increase the accuracy of the accessibility configuration. As used herein, the term “prompt” can refer to an input sequence generated to direct a corresponding machine-learning model's generation process towards producing a target output. In some instances, a filtering prompt includes a sequence of text tokens in a specific format (e.g., text, XML data, JSON data) and language (e.g., English, Korean).

In some instances, the prompts are machine-generated prompts that are generated by one or more computer systems without user intervention. For example, the one or more filtering prompts can be constructed using prompt engineering. Prompt engineering can include techniques for designing and implementing prompts within a machine-learning system to generate target responses or actions. In some instances, prompt engineering leverages a combination of linguistic approaches, machine-learning algorithms, and domain knowledge to formulate prompts that elicit specific outputs from a corresponding machine-learning model. The prompt engineering process typically begins with an analysis of a target or a problem domain, followed by the formulation of prompts tailored to achieve the desired results.

As an illustrative example for optimizing prompts, a prompt P can be defined as a sequence of tokens, tailored to elicit specific responses from a machine-learning model. The model employs an objective function O(P, R) to evaluate the quality of generated responses R given the prompt P. The responses R can be generated based on a machine-learning language model LM processing the prompt P (e.g., the function LM(P)). Different types of objective functions can be selected depending on the task and targeted output. For example, an objective function can correspond to a text summarization technique using ROUGE scores. In another example, the objective function can correspond to a translation quality assessment technique using BLEU scores. In some instances, optimization techniques like gradient descent or evolutionary algorithms are used iteratively refine the prompt P to maximize O(P, R), to facilitate the model to consistently produce accurate, relevant, and contextually appropriate outputs (e.g., the accessibility configuration). For example, the optimal prompt P* can be determine based on maximizing the objective function O:

$${P}^{*} = arg max O ( P , LM ( P ) ) \qquad Equation ( 1 )$$

Through the iterative refinement process, prompt engineering enhances the corresponding model's performance across various natural language processing tasks, such as generating the accessibility configuration that are contextually relevant to the input intent 108, the output intent 110, and the ability profile 112.

In some instances, prompt engineering includes a selection of input formats and structures. The input-format selection can include determining the syntactic and semantic characteristics of the prompts that will effectively guide the machine-learning model towards the desired outputs. In some instances, linguistics and computational linguistics can be used to select input formats that are semantically meaningful and contextually relevant. The input-format selection can ensure that the prompts effectively communicate the desired tasks or questions to the machine-learning model. The prompt engineering process can also include an optimization of prompt parameters. The optimization can include fine-tuning various parameters such as prompt length, complexity, and specificity to enhance the machine-learning model's performance on targeted tasks. Different prompt formulations and configurations such as grid search or Bayesian optimization can be implemented to optimize the prompt parameters. Additionally or alternatively, techniques such as zero-shot learning or few-shot learning can be implemented to fine-tune the machine-learning models to generalize from limited prompt examples.

The prompt engineering process can be configured based on an underlying machine-learning model architecture and training data. For example, an appropriate pre-trained machine-learning model architecture (e.g., GPT, BERT, or Transformer) that aligns with the task requirements and available computational resources can be identified for a given task. In some instances, the machine-learning model can be fine-tuned on task-specific data to further improve probability of outputting target responses. Various types of training datasets can be used to train and fine-tune the machine-learning model, so as to enable the machine-learning model to understand and generate responses to prompts accurately.

In some instances, an iterative process of designing, testing, and optimizing prompts is implemented based on feedback from initial model outputs. This iterative approach allows for continuous improvement and refinement of the prompt engineering process, ultimately leading to better-performing machine-learning models. Additionally or alternatively, ongoing monitoring and evaluation of model performance can be used to identify any errors or biases introduced by the prompts and prompt engineering process, in which the feedback data can be generated based on the evaluation. The feedback data can be used to further adjust the parameters of the machine-learning models, such that the machine-learning models can be updated to improve accuracy in generating the target responses.

The user-interaction system can apply the trained and fine-tuned machine-learning model to the input intent 108, the output intent 110, and the ability profile 112 to generate the accessibility configuration. To begin the deployment process, the user-interaction system can tokenize the merged data into a sequence of text tokens. For example, the merged data can be tokenized to provide the following sequence: [“You”, “are”, “an”, “assistant”, “tasked”, . . . .]. In some instances, the machine-learning model uses Byte Pair Encoding (BPE) techniques to further split a single token (e.g., “in”, “sufficient”).

The user-interaction system can assign each token with a particular index value in the vocabulary (e.g., “assistant”=E[5]). Then, the user-interaction system can convert each token into a vector representation (e.g., an embedding) based on a pre-trained embedding matrix. For example, for a vocabulary size V and embedding dimension dᵢ, the embedding matrix E is of size V×d, in which the vector eᵢ can be generated for the text token tᵢ based on using the index value looking at a corresponding row of embedding matrix E.

$$E \text{:} {e}_{i} = E [ {t}_{i} ] \qquad Equation ( 2 )$$

The user-interaction system can then process the sequence of embeddings (e₁, e₂, e₃, . . . eₙ) that represent the sequence of tokens by adding positional encodings to account for the order of tokens. In some instances, positional encodings are vectors added to each token embedding to inject information about the position of tokens in the sequence. A matrix X can be formed that includes the sequence of position-encoded vectors.

For the matrix X, the user-interaction system can then determine a contextual representation for each position-encoded vector of the matrix X. In particular, for each position-encoded vector, the user-interaction system can generate a set of Q, K, V vectors for the position-encoded vector. As described herein, a Q vector can represent what information the token is querying about other tokens, a K vector can represent the token's context used to establish relationships with other tokens, and a V vector can represent the token's actual content/information.

In some instances, to enhance the model's ability to capture various types of relationships, the position-encoded vector can be represented by multiple sets of Q, K, and V matrices (i.e., multi-head attention). Each set of Q, K, V vectors, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

An attention score can be calculated for the set of Q, K, V vectors as follows:

$$Attention ( Q , K , V ) = softmax ( ( {QK}^{T} ) / √ ( {d}_{k} ) ) V \qquad Equation ( 3 )$$

The (QK^{T})/√(dₖ) can be used to compute the raw attention scores, in which dₖ is the dimensionality of the key vectors. Then, the softmax function is applied to the raw attention score to normalize it into a probability distribution. The user-interaction system can apply the attention score to a V vector of the corresponding set of Q, K, V vectors, such that the weighted Q, K, V vectors can be used as the contextual representation of the position-encoded vector of matrix X. In the instances in which multi-head attention is used, the multiple sets of weighted Q, K, V vectors can be concatenated and linearly transformed using a weight matrix W^{O} to generate the contextual representation of the position-encoded vector. The above process can be iterated through other position-encoded vectors of matrix X to generate a set of contextual representations associated with the merged data.

The user-interaction system can then apply the machine-learning model to the set of contextual representations to generate the accessibility configuration. In particular, the machine-learning model can process the set of contextual representations to predict each token of the accessibility configuration, in which the output tokens can correspond to the accessibility configuration.

### 4. Modifying User Interface Elements Using AbleUI

The accessibility configuration can include any combinations of input or output GUI elements that can be used to generate content that can dynamically adapt to individual users'abilities. In addition, the accessibility configuration can be generated across different time ranges, such that the GUI of the application 102 can modify itself as those user abilities change over time. The accessibility configuration can include an input accessibility configuration and an output accessibility configuration. An input accessibility configuration can include selecting and/or customizing one or more input GUI elements from an input library 114, including but not limited to screen inputs, gesture-based inputs, inputs via assistive devices, and voice input. For example, the input accessibility configuration can include increasing the size of the virtual keyboard presented on the GUI (to assist users with motor impairment) and reducing the amount of input data to be entered to trigger the event 106 (to assist users with cognitive impairment). The input accessibility configuration can also activate one or more accessory devices designed to aid individuals with disabilities or impairments in performing tasks that might otherwise be difficult or impossible for them. For example, input accessibility configuration can activate voice recognition of a smart speaker device to accommodate for users classified as having fine-motor impairment. The above examples are for illustrative purposes only, and other examples of the input accessibility configurations can be contemplated by a skilled person in the art.

Similarly, the output accessibility configuration can include selecting or customizing one or more GUI elements from the output library 116 to determine how the output is to be displayed or presented on the application 102 based on the output intent 110 and the ability profile 112. In some instances, the output data can include but are not limited to text, image/icon, video, haptic feedback, audio/voice, light sequences, and/or assistive devices. Combinations of different types of data can be identified based on the output accessibility configuration. For example, the output accessibility configuration can specify generating haptic feedback in response to clicking certain content elements presented on the pages 104 to notify the user of the correct selection of the relevant data. In another example, closed captioning can be generated with the video presented on the application 102. The above examples are for illustrative purposes only, and other examples of the output accessibility configurations can be contemplated by a skilled person in the art.

In some instances, the input library 114 or output library 116 can include relational databases that include traditional SQL-based systems such as MySQL, PostgreSQL, and Microsoft SQL Server, which use structured tables and predefined schemas to organize data efficiently. As an alternative to relational databases, non-relational databases like MongoDB or Cassandra can be used for handling unstructured or semi-structured content elements, offering schema flexibility and high availability. In cases where flexibility in data modeling is required, hybrid databases such as NewSQL solutions offer both relational consistency and NoSQL-like scalability. Additionally, graph databases like Neo4j or Amazon Neptune can be integrated alongside relational databases to represent complex relationships between content elements, enabling more advanced queries for connected data. Other examples of databases can include embedded databases such as SQLite, RocksDB, or DuckDB.

In addition to GUI elements, other components of the application 114 can also be dynamically modified in accordance with the accessibility configuration. For example, the user-interaction system can reduce a number of available options on a particular page of the application 102 to accommodate for a user with cognitive impairments. In another example, the user-interaction system can reduce the total number of pages for a particular sequence of the events, to address a different user with memory issues. As a result, the user-interaction system would dynamically analyze the user's personal ability levels along a series of attributes associated with the input, then uses the accessibility configuration to dynamically generate the best method of presenting information and receiving additional input on a graphical user interface (GUI).

### C. Techniques for Detection and Degradation of User Ability

As described herein, the user profile can be actively updated to reflect certain characteristics or ability diminishment associated with the user. For example, consistent activity patterns of the user entering data with typographical errors can indicate certain motor-based impairments. Such user activity patterns can be tracked across time periods to track such degradation of the user abilities. FIG. 2 illustrates a schematic 200 diagram of techniques for detection and degradation of user ability, according to some embodiments. As shown in FIG. 2, a degradation-detection component of the AbleUI system monitors for missed or delayed interactions of a given application (e.g., the application 102 of FIG. 1) with the user, and data that are not matching the input criteria are signaled for tracking.

Various types of sensory attributes can be detected and tracked to estimate the level of user ability. For example, a sensory attribute can include: (i) hearing such as left and right ear, strength, tonal value, word separation, and comprehension; (ii) eyesight such as blurriness, letter, word, and number recognition, shapes, color, pattern, symmetry, alignment, depth comprehension, and for both left and right eyes; (iii) motor control including an ability to trace lines or shapes on a screen. Ability to touch targets presented; (iv) comprehension in answering basic questions after reading or hearing a scenario; (v) memory associated with recall of short, medium, and long term memory; (vi) physical dexterity that could measure attributes like gait, motion, hand gestures, etc.; and (vii) other attributes that may affect day-to-day life, health, and safety. User activity patterns can then be used to interpret an estimated level of certain categories of sensory attributes, which can then be translated into appropriately updating user interfaces of applications to increase engagement and reduce errors.

The degradation-monitoring system 202 (“AbleUI monitor”) can be configured to detect an estimated level of user ability for use in determining how best applications of the device can interact with a user. Various approaches can be implemented to detect and track activity patterns across time periods. For example, the activity patterns can be tracked manually through explicit user selection. For example, a “settings” app 204 can be implemented, in which values and configurations that indicate the estimated level of user ability can be entered by the user, a proxy, or a caregiver.

In another example, collecting activity patterns and detecting the estimated level of user ability can be performed implicitly via a “testing” app 206. The testing app 206 can be formatted as an engaging application like a game, story, quiz, or puzzle that is configured to gather information based on how the user interacts successfully or unsuccessfully with the system and future applications. In some instances, the order of conducting tests may start with broad factors and continue narrowing to specific tests of estimating user abilities. For example, one test may start with playing a snippet of audio, while a subsequent test may evaluate for left and right ear levels. The testing method could establish baseline values for various sensory attributes of a user. In some instances, the testing app 206 can be run only on first contact, or periodically to update the estimated level of user ability.

In yet another example, detecting the estimated level of user ability can be performed via observed interactions with the degradation-monitoring system 202. If a user is asked for input and fails to provide it within a provided time, that can be detected by an event anomaly subsystem 208 as a signal to adjust subsequent interactions. In yet another example, a keepalive watchdog subsystem 210 can be used to detect the level of user ability via missed user interactions. For example, if a user is presented with a button, but they keep touching the area outside the button area or hit the wrong button to go back repeatedly.

The keepalive watchdog subsystem 210 can use these types of missed interactions as signals to determine the estimated level of user ability and update the user-interaction system. The keepalive watchdog subsystem 210 can also detect failure to provide any input within a given amount of time. Such failure can be a signal that (combined with other signals) may indicate that the user's abilities have degraded to the point that they are unable to interact with the system given the current parameters. The signal can then be used to adjust the settings of the interface. The signal can also be used to notify a caregiver to take remedial actions.

The degradation-monitoring system 202 can further process the estimated level of user ability across various components of the AbleUI system. For example, the degradation-monitoring system 202 can update an ability state database 212 and/or an ability profile 214 to incorporate the estimated level of user ability. The updated ability state database 212 and/or an ability profile 214 can then be used by the downstream applications to determine the accessibility configuration and modify input and output data elements of the application. In some instances, the degradation-monitoring system 202 can detect an ability change event 216 based on the estimated level of user ability. For example, the ability change event 216 can indicate degradation of user vision or hearing.

### D. Techniques for Automatic Disability Regression Measurement

Once a baseline ability measurement of the user is determined by a degradation-monitoring system (e.g., the degradation-monitoring system 202 of FIG. 2), the AbleUI system will continue interacting with the user to dynamically determine how the interface is modified based on continues degradation of user abilities over time. FIG. 3 illustrates a schematic diagram 300 for automatic disability regression measurement, according to some embodiments. For example, a regression analyzer 302 of the AbleUI system can be configured to interact with a user with vision problems by switching to spoken interactions, but at a later time provide an ability to update the interface to include haptic feedback and gesture based controls as the user is determined to develop hearing and motor-control degradations.

In some instances, the regression analyzer 302 is an automated mechanism that accesses an estimated level of user ability from the degradation-detection component 202 (e.g., the degradation-detection component 202 of FIG. 2) and determines a rate of ability degradation based on user-interaction patterns and failure rates. The rate of ability degradation can be assigned to each interaction mode including touch, mouse, trackpad, trackball, button, pen input, keyboard, voice, motion, gesture, and assistive devices (e.g., breath, morse, etc.). Additionally or alternatively, the rate of the ability degradation can also be used to measure progress in healing after a health event (i.e. stroke, fall, or surgery).

As an illustrative example, an interaction system typically presents the user with an output then waits for the user to indicate their corresponding input. The regression analyzer 302 can measure input interaction based on measured time between display and input, accuracy of input (i.e. missing the target), and success rate of the system determining intent. Based on such measurements, the regression analyzer 302 can estimate the rate of ability degradation across a time period. In another example, if the user uses voice to indicate intent but the system fails to understand the input, the regression analyzer 302 can determine the rate of change to reflect the user's diminishing ability to speak and input abilities (e.g., voice, gesture, movement, etc.).

The rates of user ability degradation can also be determined by processing interaction data of the user using a machine-learning model. Examples of the machine-learning model (including sub-models of the multimodal model) can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods. Additionally or alternatively, the machine-learning model can include anomaly detection algorithms, such as KNN, random or isolation forest, robust covariance, support vector machine (SVM), stochastic gradient descent (SGD), k-means, or long short-term memory (LSTM). The machine-learning model can also be used to detect assistive or user input device failures.

The AbleUI system may then collect the rates of ability degradation across different interaction mode and use the result to adjust its interaction model to optimize for an individual user. For example, the rates of ability degradation can be used to update the social threshold data 306, the ability state database 308, the ability profile 310, and/or the user settings 312, such that downstream applications can modify the interface elements to increase accessibility of features for users with continuing degradation of abilities.

### E. Techniques for Mapping Application Intent to Outputs and Inputs

FIG. 4 illustrates a mechanism to map application intent to outputs and inputs, according to some embodiments. As shown in FIG. 4, an application 402 (e.g., the application 102) can identify what it expects in order to continue (e.g., a list of options), wants to show the user (e.g., a numerical value), and/or the order of actions needed to achieve an outcome.

Various aspects of the user-interaction system can be accessed as a specification 404 or an SDK 606 to allow an application developer to express its user interface and interaction model of the application 402. For example, the specification 404 or an SDK 606 can be used to access and process the requirements of the AbleUI system in an abstract manner, at times in the form of a JSON, Graph, or XML expression, or a custom format that helps the application 402 to convert such requirement into interface elements that facilitate actual user interactions. Other types of application-development environments can be used in addition or as an alternative to the SDK 606, which can include application-development service or process implemented in-app, on the device (e.g., a mobile or desktop application), in one or more gateways, or on a cloud service.

The specification 404 corresponds to a document or file that defines the structure, behavior, and requirements of the user-interaction system. It serves as a blueprint for developers to outline expected functionalities, interfaces, and constraints when incorporating features of the AbleUI system (e.g., the ability profile) into the application 402. The specification 404 can cover various aspects such as APIs, protocols, data formats, or software packages. For example, in software packaging, the specification 404 can detail how the application 402 should interact with the AbleUI system.

The SDK 406 includes a collection of tools, libraries, documentation, and sample code that can be used to dynamically implement one or more accessibility features of the application 402. In particular, the SDK 406 can include an API, debugging tools, emulators, and utilities that streamline implementation of the AbleUI system. In some instances, the SDK 406 can include pre-built functionalities (e.g., function call to generate accessibility configuration) and reducing the need for developers to write everything from scratch. The specification 404 and the SDK 406 can thus be used individually or in tandem to allow the application 402 to dynamically adjust the corresponding input and output based on the estimated level of user's abilities and corresponding rate of ability degradation.

The application 402 can utilize the specification 404 and the SDK 406 to specify an input intent 408, an output intent 410, and a sequence of events 412. These input intent 408, an output intent 410, and a sequence of events 412 can be mapped into different pages or events of the application. Once the accessibility configuration is generated based on the above input and the ability profile generated by the AbleUI system, appropriate interface elements are enabled and customized (e.g., touch, voice, gesture) to increase engagement of certain users with degradation of cognitive and sensory abilities.

For example, the user may be expected to provide the input intent 404 to allow the application 402 to perform its functions using clicking or tapping on a control, entering text, gesture, movement, and voice response/command. In another example, the output intent 406 identifies a target outcome of an application or system based on interactions performed by the user. Certain types of output data can be selected to be displayed in one or more pages of the application 402. For example, the output can include visual elements including icons, text, images, video, animation, control elements (buttons, sliders, input fields, etc.), charts, 3D models, augmented reality overlays, and virtual reality scenes. Other types of output can include audio snippets, haptic vibrations, and assistive devices. The sequence of events 408 can be expressed as a series of conditional events that can be expressed as flowchart, sequence diagram, or some form of structured flow. The application 402 can be developed by specifying the above input intent 408, an output intent 410, and a sequence of events 412, such that their format and syntax are in accordance with the information and requirements provided in the specification 404 and the SDK 406.

In some instances, the application 402 can generate accessibility configuration by using a runtime 414 of the user-interaction system to access the ability profile, then processing the ability profile and the intents to statically or dynamically update the user interface.

### F. Methods

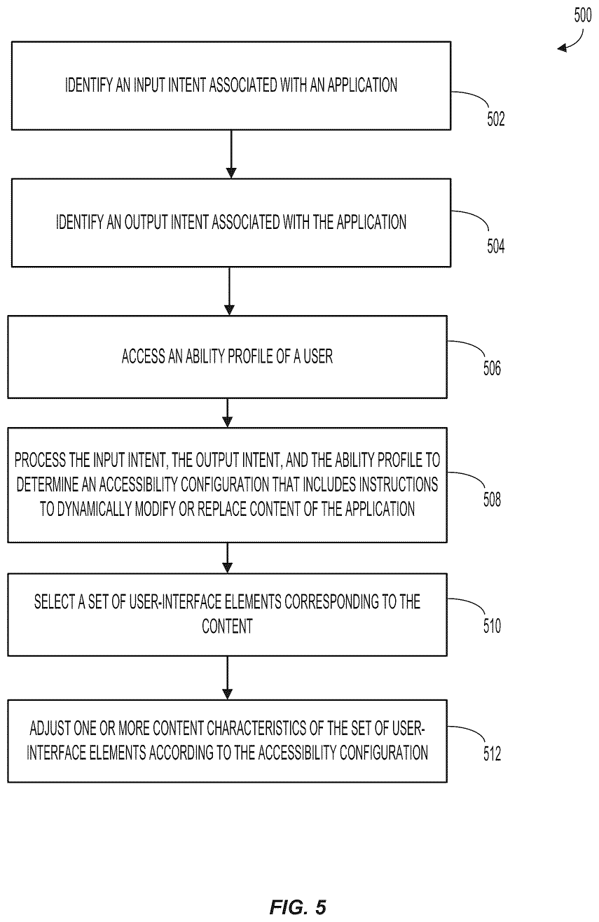

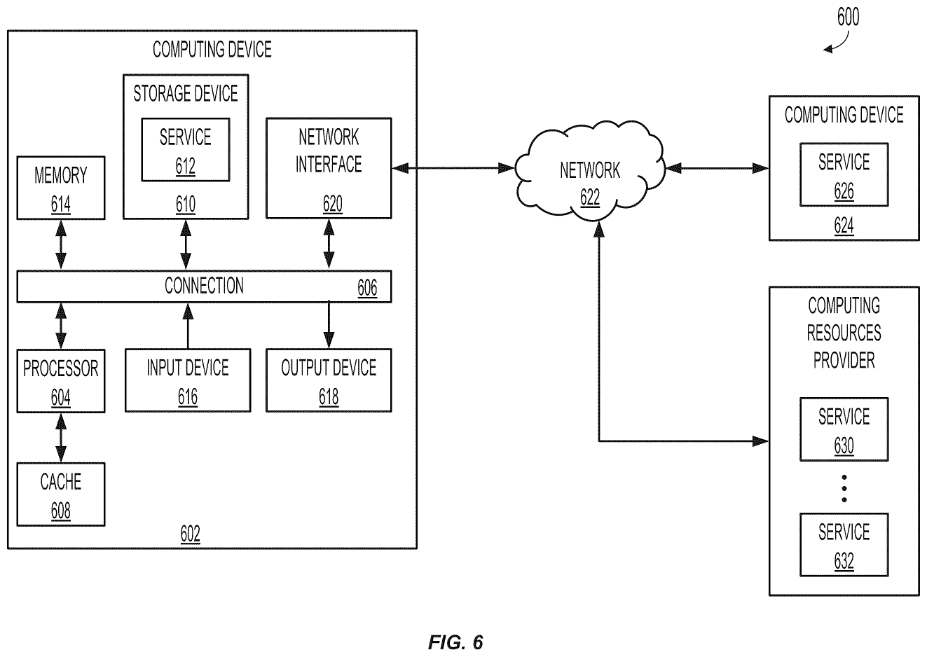

FIG. 5 shows an illustrative example of a process 500 for dynamically updating a user interface based on detection and degradation of user ability, in accordance with some embodiments. For illustrative purposes, the process 500 is described with reference to the components illustrated in FIGS. 1-4, though other implementations are possible. For example, the program code for the user-interaction system 100 of FIG. 1, is executed by one or more processing devices to cause a server system (e.g., the computing device 602 of FIG. 6) to perform one or more operations described herein.

At step 502, the user-interaction system identifies an input intent associated with an application. In some instances, the input intent identifies one or more intended inputs to the application to trigger a particular event. The application can be encoded to identify types of data that need to be presented to the user, and what type of input they expect. In some instances, the input intent is expressed in a mode-independent fashion, allowing the user-interaction system to determine how best to dynamically generate UI/UX controls for specific application usages and various types of users. As an illustrative example, the input intent can include a prompt for selecting a small thumbnail image depicting palm trees and beach.

As described herein, the event can refer to any user action or system occurrence that triggers a response within the application. The event can be triggered based on user interactions, background processes, or external inputs. Example types of events can include user events (e.g., taps, swipes, long presses, text input) and system events (e.g., application lifecycle changes, network status updates, push notifications). In some instances, events are typically handled using event listeners, callbacks, or reactive programming techniques to ensure the application responds appropriately to different actions. The event can specify one or more outputs that are triggered based on input data inputted by the user.

At step 504, the user-interaction system identifies an output intent associated with the application. In some instances, the output intent identifies one or more expected outputs associated with the particular event being triggered in response to the one or more intended inputs. Continuing with the example of selecting the thumbnail image (e.g., image of a beach with palm trees), the output intent is to navigate to another page of the application that plays a video of Cancun beaches and resorts.

In some instances, the input intent or the output intent are specified using a software development environment associated with the degradation-monitoring system. For example, the input and output intent can be specified and encapsulated as a software development kit (SDK) as well as an on-device background service or process (to track, process, and proxy events), or a cloud-based service, such that the features can be accessed and embedded in the application, along with a runtime, and active system processes.

At step 506, the user-interaction system accesses an ability profile of a user. The ability profile can include one or more characteristics associated with a cognitive or sensory ability of the user, and the ability profile is generated by a degradation-monitoring system. For example, the ability profile can include a name, an address, age, and gender of the user. In some instances, the ability profile can determine estimated level of ability degradation and rates of degradation change over a time course, either of which can be determined based on active learning of computing operations (e.g., inputs, failure to respond to certain pages) performed by the user across various applications. The active learning facilitates the ability profile to be dynamically updated in real-time.

In some instances, the ability profile indicates an estimated level of ability degradation associated with the cognitive or sensory ability of the user. Various types of sensory attributes can be detected and tracked to estimate the level of user ability. For example, a sensory attribute can include: (i) hearing such as left and right ear, strength, tonal value, word separation, and comprehension; (ii) eyesight such as blurriness, letter, word, and number recognition, shapes, color, pattern, symmetry, alignment, depth comprehension, and for both left and right eyes; (iii) motor control including an ability to trace lines or shapes on a screen. Ability to touch targets presented; (iv) comprehension in answering basic questions after reading or hearing a scenario; (v) memory associated with recall of short, medium, and long term memory; (vi) physical dexterity that could measure attributes like gait, motion, hand gestures, etc.; and (vii) other attributes that may affect day-to-day life, health, and safety. User activity patterns can then be used to interpret an estimated level of certain categories of sensory attributes, which can then be translated into appropriately updating user interfaces of applications to increase engagement and reduce errors.

The ability profile can also indicate an estimated rate of ability degradation associated with the cognitive or sensory ability of the user. The rate of ability degradation can be assigned to each interaction mode including touch, mouse, trackpad, trackball, button, pen input, keyboard, voice, motion, gesture, and assistive devices (e.g., breath, morse, etc.). Additionally or alternatively, the rate of the ability degradation can also be used to measure progress in healing after a health event (i.e. stroke, fall, or surgery).

In some instances, the ability profile is generated based on activity patterns associated with the user, in which the activity patterns are collected based on one or more user interactions with a tester application. The testing app can be formatted as an engaging application like a game, story, quiz, or puzzle that is configured to gather information based on how the user interacts successfully or unsuccessfully with the system and future applications. In some instances, the order of conducting tests may start with broad factors and continue narrowing to specific tests of estimating user abilities.

At step 508, the user-interaction system processes the input intent, the output intent, and the ability profile to determine an accessibility configuration that includes instructions to dynamically modify or replace content of the application. In some instances, dynamically modifying or replacing the content increases accessibility of the application by the user.

In some instances, the accessibility configuration is determined by processing the input intent, the output intent, and the ability profile using a machine-learning model. Examples of the machine-learning model (including sub-models of the multimodal model) can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods.

In some instances, the machine-learning model is a transformer model (e.g., a large-language model (LLM)) obtained from a models database. In some instances, the machine-learning model is trained using self-supervised learning based on a large corpus of text data, such that the machine-learning model can generate narratives. In addition to training the model, various prompts can be used for prompt engineering of the machine-learning model for generating the narratives. Examples of the machine-learning model can include, but are not limited to, BERT model, Claude LLM, Falcon 40B, Ernie, GPT-3, GPT-3.5, GPT 4, Lamda, and Llama.

At step 510, the user-interaction system selects a set of user-interface elements corresponding to the content. In some instances, the set of user-interface elements include icons, text, images, video, animation, control elements (buttons, sliders, input fields, etc.), charts, 3D models, augmented reality overlays, and virtual reality scenes.

The content can be associated with a page, which refers to a distinct screen or view within the application that presents the set of user-interface elements. Each page typically serves a specific function, such as displaying a user profile, showing a list of items, or providing a form for input. In some instances, the page can include various input and output graphical user interface elements that can be presented on a user interface, in which certain interactions with the user elements trigger an action or an event.

At step 512, the user-interaction system adjusts one or more content characteristics of the set of user-interface elements according to the accessibility configuration. For example, the user-interaction system can enlarge a font and a button user-interface element to increase accessibility for subjects with vision impairments. Process 500 terminates thereafter.

### II. Example Systems

FIG. 6 illustrates a computing system architecture 600, including various components in electrical communication with each other, in accordance with some embodiments. The example computing system architecture 600 illustrated in FIG. 6 includes a computing device 602, which has various components in electrical communication with each other using a connection 606, such as a bus, in accordance with some implementations. The example computing system architecture 600 includes a processing unit 604 that is in electrical communication with various system components, using the connection 606, and including the system memory 614. In some embodiments, the system memory 614 includes read-only memory (ROM), random-access memory (RAM), and other such memory technologies including, but not limited to, those described herein. In some embodiments, the example computing system architecture 600 includes a cache 608 of high-speed memory connected directly with, in close proximity to, or integrated as part of the processor 604. The system architecture 600 can copy data from the memory 614 and/or the storage device 610 to the cache 608 for quick access by the processor 604. In this way, the cache 608 can provide a performance boost that decreases or eliminates processor delays in the processor 604 due to waiting for data. Using modules, methods and services such as those described herein, the processor 604 can be configured to perform various actions. In some embodiments, the cache 608 may include multiple types of cache including, for example, level one (L1) and level two (L2) cache. The memory 614 may be referred to herein as system memory or computer system memory. The memory 614 may include, at various times, elements of an operating system, one or more applications, data associated with the operating system or the one or more applications, or other such data associated with the computing device 602.

Other system memory 614 can be available for use as well. The memory 614 can include multiple different types of memory with different performance characteristics. The processor 604 can include any general purpose processor and one or more hardware or software services, such as service 612 stored in storage device 610, configured to control the processor 604 as well as a special-purpose processor where software instructions are incorporated into the actual processor design. The processor 604 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 604 can be a microprocessor, a microcontroller, a digital signal processor (“DSP”), or a combination of these and/or other types of processors. In some embodiments, the processor 604 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 600, an input device 616 can represent any number of input mechanisms, such as a microphone for speech, a touch-sensitive screen for gesture or graphical input, keyboard, mouse, motion input, pen, and other such input devices. An output device 618 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 600. In some embodiments, the input device 616 and/or the output device 618 can be coupled to the computing device 602 using a remote connection device such as, for example, a communication interface such as the network interface 620 described herein. In such embodiments, the communication interface can govern and manage the input and output received from the attached input device 616 and/or output device 618. As may be contemplated, there is no restriction on operating on any particular hardware arrangement and accordingly the basic features here may easily be substituted for other hardware, software, or firmware arrangements as they are developed.

In some embodiments, the storage device 610 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 610 can include hardware and/or software services such as service 612 that can control or configure the processor 604 to perform one or more functions including, but not limited to, the methods, processes, functions, systems, and services described herein in various embodiments. In some embodiments, the hardware or software services can be implemented as modules. As illustrated in example computing system architecture 600, the storage device 610 can be connected to other parts of the computing device 602 using the system connection 606. In some embodiments, a hardware service or hardware module such as service 612, that performs a function can include a software component stored in a non-transitory computer-readable medium that, in connection with the necessary hardware components, such as the processor 604, connection 606, cache 608, storage device 610, memory 614, input device 616, output device 618, and so forth, can carry out the functions such as those described herein.

The disclosed systems and service of a user-interaction system (e.g., the user-interaction system 100 described herein at least in connection with FIG. 1) can be performed using a computing system such as the example computing system illustrated in FIG. 6, using one or more components of the example computing system architecture 600. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems associated with the user-interaction system (e.g., the user-interaction system 100 described herein at least in connection with FIG. 1) described herein by, for example, executing code using a processor such as processor 604 wherein the code is stored in memory such as memory 614 as described herein. One or more of a user device, a provider server or system, a database system, or other such devices, services, or systems may include some or all of the components of the computing system such as the example computing system illustrated in FIG. 6, using one or more components of the example computing system architecture 600 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 628. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 604 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 614 can be coupled to the processor 604 by, for example, a connector such as connector 606, or a bus. As used herein, a connector or bus such as connector 606 is a communications system that transfers data between components within the computing device 602 and may, in some embodiments, be used to transfer data between computing devices. The connector 606 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 614 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 614 can also include magnetic or optical data storage media including read-only (e.g., CD ROM and DVD ROM) or otherwise (e.g., CD or DVD). The memory can be local, remote, or distributed.

As described above, the connector 606 (or bus) can also couple the processor 604 to the storage device 610, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 610. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 606 can also couple the processor 604 to a network interface device such as the network interface 620. The interface can include one or more of a modem or other such network interfaces including, but not limited to those described herein. It will be appreciated that the network interface 620 may be considered to be part of the computing device 602 or may be separate from the computing device 602. The network interface 620 can include one or more of an analog modem, Integrated Services Digital Network (ISDN) modem, cable modem, token ring interface, satellite transmission interface, or other interfaces for coupling a computer system to other computer systems. In some embodiments, the network interface 620 can include one or more input and/or output (I/O) devices. The I/O devices can include, by way of example but not limitation, input devices such as input device 616 and/or output devices such as output device 618. For example, the network interface 620 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 602 can be connected to one or more additional computing devices such as computing device 624 via a network 622 using a connection such as the network interface 620. In such embodiments, the computing device 624 may execute one or more services 626 to perform one or more functions under the control of, or on behalf of, programs and/or services operating on computing device 602. In some embodiments, a computing device such as computing device 624 may include one or more of the types of components as described in connection with computing device 602 including, but not limited to, a processor such as processor 604, a connection such as connection 606, a cache such as cache 608, a storage device such as storage device 610, memory such as memory 614, an input device such as input device 616, and an output device such as output device 618. In such embodiments, the computing device 624 can carry out the functions such as those described herein in connection with computing device 602. In some embodiments, the computing device 602 can be connected to a plurality of computing devices such as computing device 624, each of which may also be connected to a plurality of computing devices such as computing device 624. Such an embodiment may be referred to herein as a distributed computing environment.

The network 622 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 622 can be wired connections, wireless connections, or combinations thereof. Communications via the network 622 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 622, within the computing device 602, within the computing device 624, or within the computing resources provider 628 can include information, which also may be referred to herein as content. The information may include text, graphics, audio, video, haptics, and/or any other information that can be provided to a user of the computing device such as the computing device 602. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 602 and presented to a user of the computing device 602 using forms that are perceptible via sight, sound, smell, taste, touch, or other such mechanisms. In some embodiments, communications over the network 622 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 602 and/or the computing device 624 can be connected to a computing resources provider 628 via the network 622 using a network interface such as those described herein (e.g. network interface 620). In such embodiments, one or more systems (e.g., service 630 and service 632) hosted within the computing resources provider 628 (also referred to herein as within “a computing resources provider environment”) may execute one or more services to perform one or more functions under the control of, or on behalf of, programs and/or services operating on computing device 602 and/or computing device 624. Systems such as service 630 and service 632 may include one or more computing devices such as those described herein to execute computer code to perform the one or more functions under the control of, or on behalf of, programs and/or services operating on computing device 602 and/or computing device 624.

For example, the computing resources provider 628 may provide a service, operating on service 630 to store data for the computing device 602 when, for example, the amount of data that the computing device 602 exceeds the capacity of storage device 610. In another example, the computing resources provider 628 may provide a service to first instantiate a virtual machine (VM) on service 632, use that VM to access the data stored on service 632, perform one or more operations on that data, and provide a result of those one or more operations to the computing device 602. Such operations (e.g., data storage and VM instantiation) may be referred to herein as operating “in the cloud,” “within a cloud computing environment,” or “within a hosted virtual machine environment,” and the computing resources provider 628 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 628 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 630 and service 632 may implement versions of various services (e.g., the service 612 or the service 626) on behalf of, or under the control of, computing device 602 and/or computing device 624. Such implemented versions of various services may involve one or more virtualization techniques so that, for example, it may appear to a user of computing device 602 that the service 612 is executing on the computing device 602 when the service is executing on, for example, service 630. As may also be contemplated, the various services operating within the computing resources provider 628 environment may be distributed among various systems within the environment as well as partially distributed onto computing device 624 and/or computing device 602.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 602) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 500 of FIG. 5). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 602.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
identifying an input intent associated with an application, wherein the input intent identifies one or more intended inputs to the application to trigger a particular event;
identifying an output intent associated with the application, wherein the output intent identifies one or more expected outputs associated with the particular event being triggered in response to the one or more intended inputs;
accessing an ability profile of a user, wherein the ability profile includes one or more characteristics associated with a cognitive or sensory ability of the user, and wherein the ability profile is generated by a degradation-monitoring system;
processing the input intent, the output intent, and the ability profile to determine an accessibility configuration that includes instructions to dynamically modify or replace content of the application, wherein dynamically modifying or replacing the content increases accessibility of the application by the user;
selecting a set of user-interface elements corresponding to the content; and
adjusting one or more content characteristics of the set of user-interface elements according to the accessibility configuration.

2. The computer-implemented method of claim 1, wherein the input intent or the output intent are specified using a software development environment associated with the degradation-monitoring system.

3. The computer-implemented method of claim 1, wherein the ability profile indicates an estimated level of ability degradation associated with the cognitive or sensory ability of the user.

4. The computer-implemented method of claim 1, wherein the ability profile indicates an estimated rate of ability degradation associated with the cognitive or sensory ability of the user.

5. The computer-implemented method of claim 1, wherein the accessibility configuration is determined by processing the input intent, the output intent, and the ability profile using a machine-learning model.

6. The computer-implemented method of claim 1, wherein the set of user-interface elements include icons, text, images, video, animation, control elements (buttons, sliders, input fields, etc.), charts, 3D models, augmented reality overlays, and virtual reality scenes.

7. The computer-implemented method of claim 1, wherein the ability profile is generated based on activity patterns associated with the user, wherein the activity patterns are collected based on one or more user interactions with a tester application.

8. A system comprising:
one or more processors; and
memory storing thereon instructions that, as a result of being executed by the one or more processors, cause the system to perform operations comprising:
identifying an input intent associated with an application, wherein the input intent identifies one or more intended inputs to the application to trigger a particular event;
identifying an output intent associated with the application, wherein the output intent identifies one or more expected outputs associated with the particular event being triggered in response to the one or more intended inputs;
accessing an ability profile of a user, wherein the ability profile includes one or more characteristics associated with a cognitive or sensory ability of the user, and wherein the ability profile is generated by a degradation-monitoring system;
processing the input intent, the output intent, and the ability profile to determine an accessibility configuration that includes instructions to dynamically modify or replace content of the application, wherein dynamically modifying or replacing the content increases accessibility of the application by the user;
selecting a set of user-interface elements corresponding to the content; and
adjusting one or more content characteristics of the set of user-interface elements according to the accessibility configuration.

9. The system of claim 8, wherein the input intent or the output intent are specified using a software development environment associated with the degradation-monitoring system.

10. The system of claim 8, wherein the ability profile indicates an estimated level of ability degradation associated with the cognitive or sensory ability of the user.

11. The system of claim 8, wherein the ability profile indicates an estimated rate of ability degradation associated with the cognitive or sensory ability of the user.

12. The system of claim 8, wherein the accessibility configuration is determined by processing the input intent, the output intent, and the ability profile using a machine-learning model.

13. The system of claim 8, wherein the set of user-interface elements include icons, text, images, video, animation, control elements (buttons, sliders, input fields, etc.), charts, 3D models, augmented reality overlays, and virtual reality scenes.

14. The system of claim 8, wherein the ability profile is generated based on activity patterns associated with the user, wherein the activity patterns are collected based on one or more user interactions with a tester application
15. A non-transitory, computer-readable storage medium storing thereon executable instructions that, as a result of being executed by one or more processors of a computer system, cause the computer system to perform operations comprising:
identifying an input intent associated with an application, wherein the input intent identifies one or more intended inputs to the application to trigger a particular event;
identifying an output intent associated with the application, wherein the output intent identifies one or more expected outputs associated with the particular event being triggered in response to the one or more intended inputs;
accessing an ability profile of a user, wherein the ability profile includes one or more characteristics associated with a cognitive or sensory ability of the user, and wherein the ability profile is generated by a degradation-monitoring system;
processing the input intent, the output intent, and the ability profile to determine an accessibility configuration that includes instructions to dynamically modify or replace content of the application, wherein dynamically modifying or replacing the content increases accessibility of the application by the user;
selecting a set of user-interface elements corresponding to the content; and
adjusting one or more content characteristics of the set of user-interface elements according to the accessibility configuration.

16. The non-transitory, computer-readable storage medium of claim 15, wherein the input intent or the output intent are specified using a software development environment associated with the degradation-monitoring system.

17. The non-transitory, computer-readable storage medium of claim 15, wherein the ability profile indicates an estimated level of ability degradation associated with the cognitive or sensory ability of the user.

18. The non-transitory, computer-readable storage medium of claim 15, wherein the ability profile indicates an estimated rate of ability degradation associated with the cognitive or sensory ability of the user.

19. The non-transitory, computer-readable storage medium of claim 15, wherein the accessibility configuration is determined by processing the input intent, the output intent, and the ability profile using a machine-learning model.

20. The non-transitory, computer-readable storage medium of claim 15, wherein the set of user-interface elements include icons, text, images, video, animation, control elements (buttons, sliders, input fields, etc.), charts, 3D models, augmented reality overlays, and virtual reality scenes.

21. The non-transitory, computer-readable storage medium of claim 15, wherein the ability profile is generated based on activity patterns associated with the user, wherein the activity patterns are collected based on one or more user interactions with a tester application.
